(19) United States
(12) Patent Application Publication
(10) Pub. No.: US 2005/0105768 A1
(43) Pub. Date: May 19, 2005

(54) Manipulation of image data

(76) Inventors: Guang-Zhong Yang, Epsom (GB); Laura Dempere-Marco, London (GB); Xiao Peng Hu, London (GB); Duncan Fyfe Gillies, London (GB)

Correspondence Address: HICKMAN PALERMO TRUONG & BECKER, LLP, 2055 GATEWAY PLACE, SUITE 550, SAN JOSE, CA, 95110, US

(21) Appl. No.: 10/490,128

(22) PCT Filed: Sep. 19, 2002
(86) PCT No.: PCT/GB02/04259

(30) Foreign Application Priority Data
Sep. 19, 2001 (GB) 0122601.8

(51) Int. Cl. G06K 9/00; G06F 3/00

(52) U.S. Cl. 382/103; 715/700

(57) ABSTRACT

A method of analysing an image comprises carrying out eye tracking on an observer observing the image and applying factor analysis to the fixation regions to identify the underlying image attributes which the observer is seeking.

The invention relates to the manipulation of image data, in particular such manipulation by extracting features from images using eye tracking techniques to construct a decision support network, for example in the analysis of medical images.

Eye-tracking techniques have been used to track the eye-movements of an observer observing an image and indeed extensive research into the role of saccadic eye movements—that is voluntary rapid eye movements to direct the eye at a specific point of interest—in human visual perception has been carried out for many years. Characterisation of the dynamics of saccadic eye movements and the choice of fixation points—areas dwelled on for longer than 100 ms—provides important insights into the process involved in image understanding. It is well established that when observers are presented with an image they rarely scan it systematically, but rather concentrate their vision on a number of fixation points. Such patterns tend to be repetitive, idiosyncratic and observer dependent. Eye fixations have widely been used as indices for representing the cognitive processes, the time order of the fixation points representing the actual visual search that takes place. For example, eye-tracking has been used to provide insights into how a medical expert reaches a diagnosis of a condition from visual analysis of an image such as an X-ray. Hitherto, many studies have been carried out to understand the processes by which radiologists search for visual cues that indicate a given disease.

It has been long recognised that observer variation and interpretation errors represent the weakest aspects of diagnostic imaging. To ensure more stringent quality assurance in clinical diagnosis, a wide range of Artificial Intelligence (AI) techniques have been used since the 1950s for diagnostic decision support. Despite their ability for improving diagnostic accuracy and overall reproducibility, there is a lack of a coherent and general framework for knowledge gathering for decision support systems. The inherent drawback of traditional approaches is that explicit domain knowledge representation often overlooks factors that are subconsciously applied during visual recognition. In other words, the expert is asked to describe verbally the reasons why a particular order of fixation points was adopted, and may not be aware of—and hence cannot transmit—subconscious or subliminal decisions that were followed. Furthermore, the ad hoc nature of grouping of low-level visual features means that there are no consistent ways of overall system design. Each application is treated as a new problem, and requires a considerable amount of interaction between clinical radiologists and computer scientists in order to identify intrinsic visual features that are relevant to the diagnosis. This process is further hampered by the fact that visual features may be difficult to describe and assimilation of near-subliminal information is cryptic.

A summary of the use of eye-position data for various applications is giyen in “Recording and analysing eye-position data using a microcomputer workstation” C. F. Nodine et al, Behaviour research methods, instruments and computers 1992, 24(3), 475 to 485. The paper describes the use of eye-position data collection and analysis to identify clusters of fixations and sequential analysis of the user's scan-path. Data about gaze duration and target location is analysed first in a calibration step. Then the subsequent performance of observers is monitored using eye tracking allowing the identification of potentially missed nodes. However this is a highly simplistic approach which allows only minimal inferences to be drawn from the initial analysis phase.

According to the invention there is provided a method of analysing an image comprising the steps of tracking the eye movements of an observer observing the image, identifying one or more of the observer's fixation regions, and extracting from a range of possible underlying image attributes one or more image attributes associated with the fixation region(s). As a result verbal explanation by the observer is not required and implicit or subconscious decisions can be recognised from observing the fixations.

The, or each, image attribute is preferably extracted by factor analysis, allowing a methodical and accurate identification of attributes. The, or each, image attribute may be obtained from the image using a feature extraction library. The range of possible underlying image attributes preferably comprises a subset of all image attributes in the feature extraction library identified based on explicit domain knowledge. As a result the processing burden is decreased. The fixation region may be identified by using a technique called k-mean elliptical clustering.

According to the invention there is further provided a method of developing a decision support system comprising the steps of extracting one or more image attributes, according to the method described above and correlating the extracted attributes against the observer's verbal analysis of the image. As a result a database of image attributes identified subconsciously can be complied against an explicit analysis.

According to the invention there is further provided a method of developing an image analysis training system comprising the steps of extracting image attributes as described above and representing the image attributes to a trainee.

The method preferably further comprises the step of identifying a transition sequence between fixation regions, allowing a temporal sequence to the constructed, preferably using Markov modelling.

According to the invention there is further provided a method of extracting image attributes from an image comprising the step of applying factor analysis to the tracked scan of the image by an observer. As a result, additional information concerning the observers' scan can be derived.

The invention further provides an image analysis system comprising an image display, an eye-tracker and a processor for processing tracked data to identify significant underlying image attributes and a computer program arranged to implement a method and/or a system as described above.

Embodiments of the invention will now be described by way of example with reference to the drawings, of which:

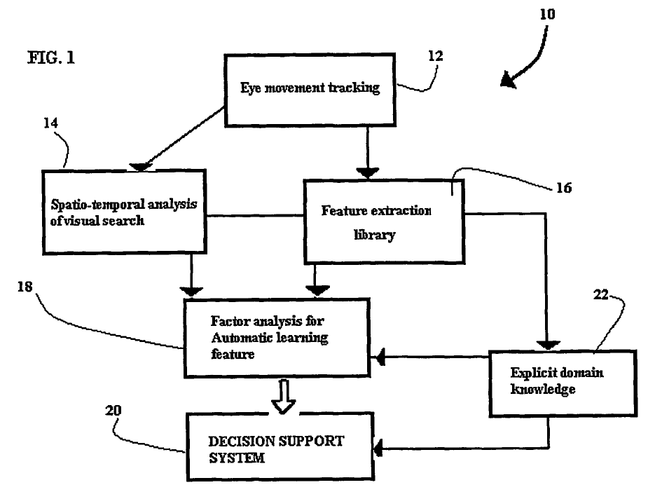

FIG. 1 is a block diagram illustrating the knowledge gathering framework;

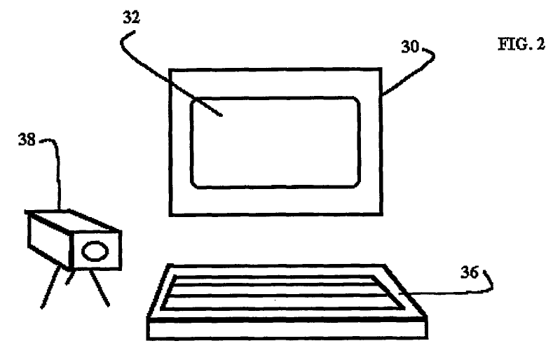

FIG. 2 is a schematic view of the basic components of the system;

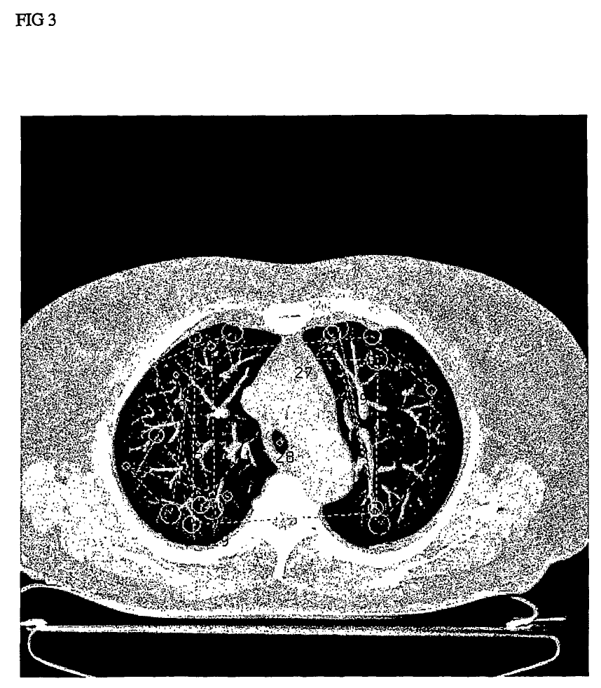

FIG. 3 is an exemplary view showing an expert's eye fixations on a lung image;

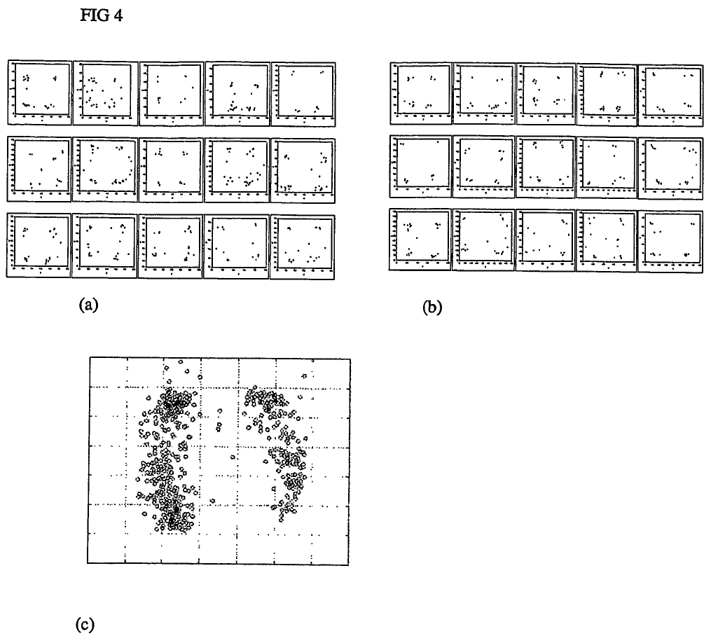

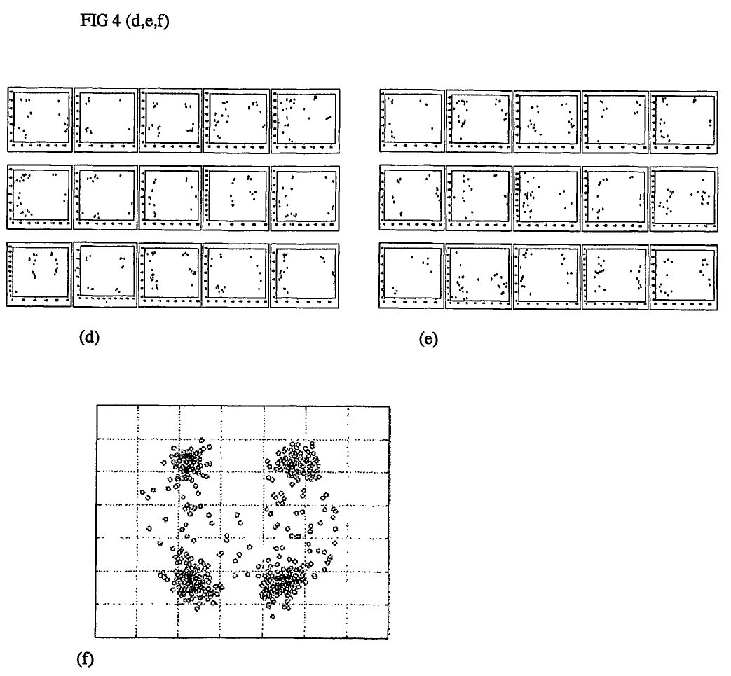

FIGS. 4a to 4f show fixation points for different observers looking at the same image;

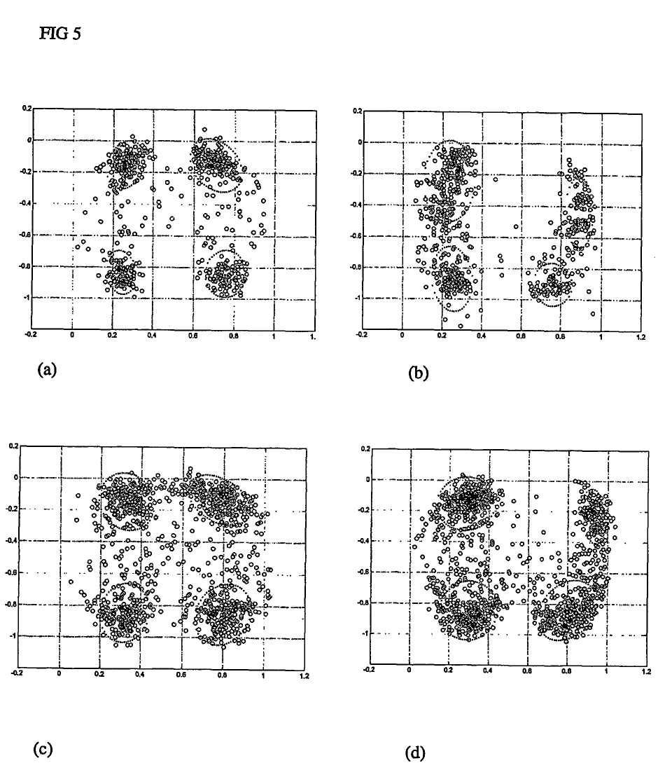

FIG. 5 shows images processed to identify clusters of fixation points;

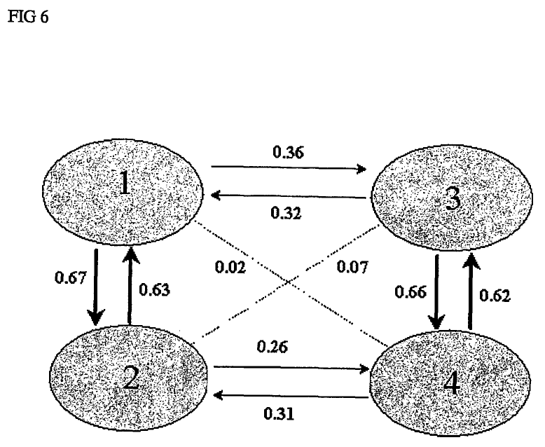

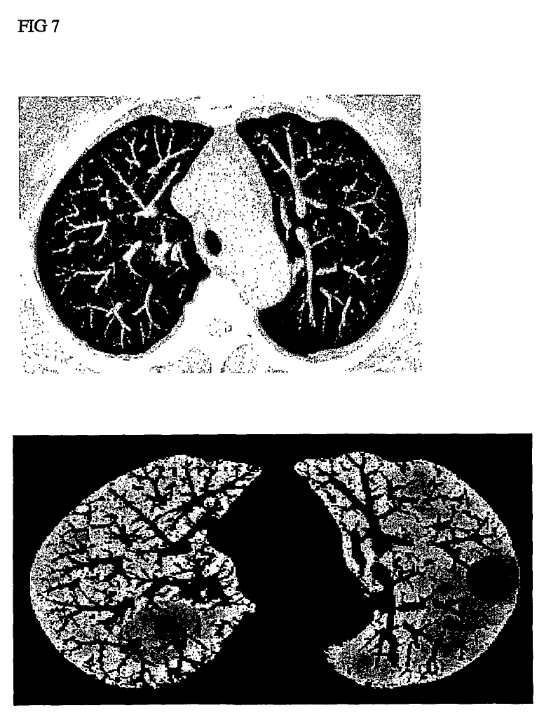

FIG. 6 is a Markov model showing transitions between clusters;

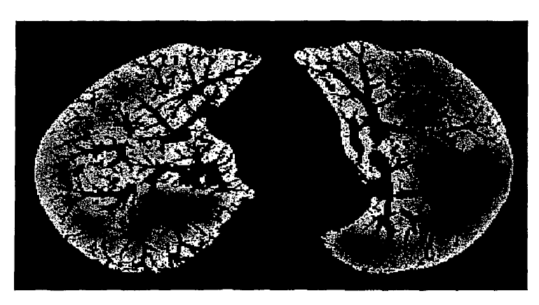

FIG. 7 shows enhanced lung image views provided according to the invention; and

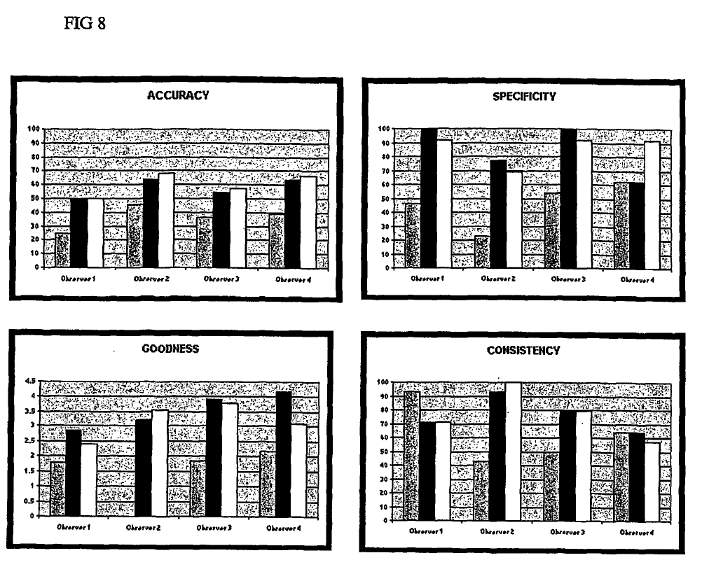

FIG. 8 shows plots of accuracy, specificity, conformance and consistency of trainees using the invention.

As discussed in more detail below, the invention provides a system of knowledge gathering for decision support in image understanding/analysis through eye-tracking. A generic image feature extraction library comprising an archive of common image features is constructed. Based on the information extracted from the dynamics of an expert's saccadic eye movements for a given image type, the visual characteristics of the image features or attributes fixated by the domain experts are determined mathematically such that the most significant parts of the image type can be identified. Thus, when a specific type of image, for example a scan of a particular part of the human body, is analysed by an expert, those of the common image attributes, or “feature extractors”, from the archive that are most relevant to the visual assessment by the expert for that image type are determined automatically from eye-tracking the expert. These attributes are aspects such as the texture of the image at the fixated point—because these are underlying features rather than the physical location or co-ordinates of a fixation point, additional information can be inferred. The dynamics of the visual search can subsequently be analysed mathematically to provide training information to novices on how and where to look for image features. The invention thus captures the encapsulating and perceptual factors that are subconsciously applied by experienced radiologists during visual assessment. The invention is enhanced by allowing the sequence of fixation points also to be analysed and applied in training and/or decision support.

FIG. 1 illustrates the basic design of the proposed knowledge gathering framework designated generally 10. An eye movement tracker 12 records spatio-temporal information of the eye movements during normal, uninterrupted, radiological interpretation sessions by experienced observers. Following from this, fixation points and saccadic eye movements are analysed 14 through spatio-temporal clustering of the fixation points and Markov modelling representing eye transitions between clusters. The information on fixation points is subsequently fed into the feature or attribute extraction library 16, which is generic and not domain specific. At the next level, factor analysis for automatic feature learning 18 is applied, which determines a group of dominant image attributes most relevant to the diagnostic process. The derived subset of extractors from the feature library is subsequently combined to form the basis for image decision support 20. Explicit domain knowledge 22 and prior information can also be incorporated at the feature extraction stage, for example to limit the number of features/attributes selected from the library to form the basis of the factor analysis, hence reducing computational burden.

FIG. 2 shows an appropriate apparatus for implementation of the invention. A computer monitor 30 displays an image 32 to be observed by an observer who can control the display using an interface such as keyboard 36. An eye tracking system 38, for example an ASL Model 504 remote eye-tracking system (Applied Science Laboratories, Massachusetts) and a DICOM image viewing emulator are used to recreate a normal reporting environment for the observers. The eye tracking equipment measures the relative position of the pupil and corneal reflection to determine the direction of gaze in a manner that will be well known to the skilled reader. The remote eye-tracking system used in this study has an accuracy of 0.5 degrees of visual angle and a resolution of 0.25 degrees. The system used in this study has a sample rate of 50 Hz and temporal averaging with a factor of 4 such that every four points are averaged to give an effective sampling rate of 12.5 Hz is used for improving the consistency of the data points. The algorithm used to obtain the fixations was based on the identification of a spatial dispersion-threshold that is to say, the proximity required for a group to be identified as a cluster of fixation points.

In the embodiment discussed below the images 32 are obtained with an ultra-fast Electron Beam Computed Tomography (EBCT) scanner (Imatron Inc., San Francisco, Calif.). In particular contiguous 3 mm axial sections of the upper and lower chest are used from subjects undergoing investigation for heart failure. The upper chest images are obtained at the level of the aortic arch and the lower chest images are obtained at the level of the pulmonary venous confluence and reconstructed using a high-resolution (bone) algorithm. The contiguous images for the upper and lower chest were displayed as Maximum Intensity Projection (MIP) images to enhance the visualisation of the peripheral vasculature.

As a preliminary step a general-purpose feature extraction library corresponding to element 16 of FIG. 1 is constructed to analyse the underlying image attributes at each fixation point. The contents of the library comprise any appropriate range of feature extractors as will be well known to the skilled reader. The design of the framework shown in FIG. 1 indicates that explicit domain knowledge can be used to limit the number of feature extractors used for each study, such that those ones that are obviously irrelevant to the study can be excluded. For example certain image attributes will only be relevant to certain image types, relating to a specific condition. As a result the computing burden is decreased.

As indicated above the preferred embodiment relates to High Resolution Computed Tomography (HRCT) image analysis. It is found that the main characteristics used to detect the abnormalities associated with heart failures indicate that textural appearance of the lung parenchyma plays a central role. As a result, those image attributes associated with texture are selected from the feature extraction library to form the basis of further analysis. In this way explicit domain knowledge has been used to limit the number of feature extractors used. In order to identify the exact definition and the type of texture descriptors that are most sensitive to the current embodiment 16 texture descriptors were used as image attributes to be analysed. These include feature extractors relating to mean, standard deviation, skewness and kurtosis, and other features that describe spatial dependence of greyscale distributions derived from the set of co-occurrence matrices as described in R. M. Haralick, “Statistical and structural approaches to texture”, in Proc. IEEE, vol. 67, pp. 786-804, 1979 which is incorporated herein by reference. Additional feature extractors relate to energy, entropy, maximum, contrast and homogeneity, the form of which will be well known to the skilled reader. The feature extractors further include the known shape descriptors short primitive emphasis (spe), long primitive emphasis (lpe), grey-level uniformity (glu) and primitive-length uniformity (ple). The last two image attributes for the feature extraction library comprise the standard features named as fractal dimension and image entropy as described in Y. Y. Tang, H. Ma, D. Xi, X. Mao, C. Y. Suen, “Modified Fractal Signature (MFS): a new approach to document analysis for automatic knowledge acquisition,” IEEE Trans. on Knowledge Data Eng., vol. 9, no. 5, pp. 747-762, 1997 which is incorporated herein by reference. A complete list of the sixteen feature extractors used to provide the feature extraction library for this mode of images is provided in Table 1 below.

TABLE 1

| | |
|---|---|
| | Entropy |
| Complexity | Fractal Dimension |
| | Primitive Length Uniformity |
| | Grey Level Uniformity |
| Run Length Parameters | Long primitive emphasis |
| | Short primitive emphasis |
| Co-occurrence matrices | Homogeneity |
| from | Contrast |
| mean values extracted | Maximum |
| | Entropy |
| | Energy |
| | Kurtosis |
| | Skewness |
| moments | Absolute deviation |
| n^{th} order statistical | Standard Deviation |
| | Mean |

Accordingly, based on explicit domain knowledge, sixteen possible relevant image attributes are identified as being potentially significant in the analysis of this image type—namely HRCT lung images. The next step is to analyse the eye-tracking data of an expert observing these images to establish which of the image attributes are in fact significant in analysing the images. This is done without verbal input by the expert but simply by analysis of the eye-tracking data as described below.

FIG. 3 illustrates an example of the CT images of the lung considered according to the described embodiment where the fixation points and saccadic eye movements are represented as circles and dotted lines respectively. The size of the circle indicates the duration of the fixations. The distribution of the fixation points of the experienced observers over 15 case studies is shown in FIG. 4. It is evident that the fixations tend to be clustered in four main regions. This is particularly clear when the data from a single observer's interrogation of all the images (i.e. 30 scenes) were projected onto a single plot in FIGS. 4(c) and 4(f) and in a preferred aspect projected fixations are used to automatically define the regions of interest on the images.

The first stage of the scan-data processing involves geometrical normalisation of the lung and the projection of the scan-data onto the normalised co-ordinate system. This normalisation process accounts for the variability of the lung geometry for different subjects, thus permitting the projection of the fixation points to a common reference space.

To identify the region containing the principle fixation points an appropriate clustering technique, for example k-mean elliptical clustering, is applied to provide the four clusters or “states” in the present embodiment, as shown in FIG. 5. Appropriate techniques will be well known to the skilled reader and are not described in detail here. To take into account the time spent at each fixation, a normalised weighting factor was provided to each fixation point and the convergence criterion was selected such that at most 1% of the fixations had a different cluster assignation in two consecutive iterations. This allows grouping of fixation points into dominant regions of interest as can be seen in the “circled” groups of fixation points shown in FIG. 5.

Once the projected fixation points are clustered into states, Markov analysis is applied to determine the sequence in which the expert looks at the states. The Markov model allows a representation of the temporal sequence of fixations by examining the transitions between states, ie clusters of fixation points. The transitions between states are used as a way of defining the dynamics of the eye movements and how different image features are compared by the expert. In parallel to this, in order to reveal the underlying visual features that were most relevant to the visual assessment, factor analysis is applied as discussed in the appendix to the 16 feature extractors selected from the image feature extraction library. As a result those image attributes most relevant to the type of image to be analysed are identified. The resolved best feature extractors are subsequently combined with information on the visual search dynamics determined by the Markov model to provide decision support and/or training on where and how to observe the underlying visual features.

Markov Modelling is a common technique of using stochastic process for analysing systems whose behaviour can be characterised by enumerating all the states it may enter. The use of Markov models for scan path analysis will be well known to the skilled reader and has been addressed by previous studies for investigating the temporal sequence of fixations as described in K. Preston White, Jr., T. L. Hutson, and T. E. Hutchinson, “Modeling human eye behavior during mammographic scanning: preliminary results”, IEEE Trans. Syst., Man, Cybern. A, vol. 27, no. 4, pp. 494-505, 1997 and S. S. Hacisalihzade, L. W. Stark and J. S. Allen, “Visual perception and sequences of eye movement fixations: a stochastic modeling approach,” IEEE Trans. Syst., Man, Cybern., vol. 22, no. 3, pp. 474-481, 1992 which are incorporated herein by reference. The preferred embodiment employs discrete-time Markov Chains (DTMC), which are first order Markov processes with a discrete state space that is observed at a discrete set of times. Regions with a higher density of fixations (see FIG. 5) were then selected as transition states for the Markov model. The remaining un-clustered region was also defined as an independent state, but was unused in further data analysis. The number of fixation clusters—four in the embodiment described and represented in FIG. 5 determined the states of the Markov model under consideration. The transition probabilities pᵢⱼ between states (ie fixation point groups) i and j were calculated by first assigning each fixation to a given cluster and defining the chain of states for every image that is, the order in which the states are observed and then counting the number of transitions for all the combinations of states (i.e. tᵢⱼ for states i and j) and normalising by the total number of transitions in that image. By excluding intra-state transitions, the actual calculations done in this study are illustrated in Equation 1, where only four independent states are considered and:

$$( \begin{matrix}* & {t}_{12} & {t}_{13} & {t}_{14} \\ {t}_{21} & * & {t}_{23} & {t}_{24} \\ {t}_{31} & {t}_{32} & * & {t}_{34} \\ {t}_{41} & {t}_{42} & {t}_{43} & *\end{matrix} ) \to ( \begin{matrix}* & {p}_{12} = \frac{{t}_{12}}{{t}_{12} + {t}_{13} + {t}_{14}} & {p}_{13} = \frac{{t}_{13}}{{t}_{12} + {t}_{13} + {t}_{14}} & {p}_{14} = \frac{{t}_{14}}{{t}_{12} + {t}_{13} + {t}_{14}} \\ {p}_{21} = \frac{{t}_{21}}{{t}_{21} + {t}_{23} + {t}_{24}} & * & {p}_{23} = \frac{{t}_{23}}{{t}_{21} + {t}_{23} + {t}_{24}} & {p}_{24} = \frac{{t}_{24}}{{t}_{21} + {t}_{23} + {t}_{24}} \\ {p}_{31} = \frac{{t}_{31}}{{t}_{31} + {t}_{32} + {t}_{34}} & {p}_{32} = \frac{{t}_{32}}{{t}_{31} + {t}_{32} + {t}_{34}} & * & {p}_{34} = \frac{{t}_{34}}{{t}_{31} + {t}_{32} + {t}_{34}} \\ {p}_{41} = \frac{{t}_{41}}{{t}_{41} + {t}_{42} + {t}_{43}} & {p}_{42} = \frac{{t}_{42}}{{t}_{41} + {t}_{42} + {t}_{43}} & {p}_{43} = \frac{{t}_{43}}{{t}_{41} + {t}_{42} + {t}_{43}} & *\end{matrix} ) \qquad ( 1 )$$

In the specific example referred to here the Markov matrices corresponding to the transitions of eye movements between different fixation regions for the experienced observers were calculated according to equation 5 as set out in Table 2 below. Preferably multiple Markov matrices corresponding to individual images observed by a common observer are summed together followed by normalisation. The single matrix describing the eye movement characteristics for each experienced observer at one given CT slice location is calculated as shown at Table 2.

TABLE 2

| | * | 0.56 | 0.41 | 0.02 | | | * | 0.9 | 0.1 | 0 | |
|---|---|---|---|---|---|---|---|---|---|---|---|
| | 0.62 | * | 0.17 | 0.21 | | | 0.44 | * | 0.08 | 0.47 | |
| {open oversize parenthesis} | 0.35 | 0.02 | * | 0.63 | {close oversize parenthesis} | {open oversize parenthesis} | 0.41 | 0.02 | * | 0.42 | {close oversize parenthesis} |
| | 0.02 | 0.21 | 0.78 | * | | | 0.03 | 0.26 | 0.71 | * | |
| | a | | | | | | b | | | | |
| | * | 0.58 | 0.40 | 0.02 | | | * | 0.48 | 0.51 | 0.01 | |
| | 0.85 | * | 0.01 | 0.14 | | | 0.74 | * | 0.09 | 0.17 | |
| {open oversize parenthesis} | 0.35 | 0.06 | * | 0.59 | {close oversize parenthesis} | {open oversize parenthesis} | 0.19 | 0.11 | * | 0.7 | {close oversize parenthesis} |
| | 0.05 | 0.50 | 0.45 | * | | | 0.02 | 0.27 | 0.71 | * | |

| | |
|---|---|
| c | d |

FIG. 6 shows the derived Markov model showing the averaged transition probabilities between the four different states in the present embodiment. It is evident that the predominant transitions are those from anterior to posterior (states 1,2 and 3,4) and vice versa. However, lateral transitions (states 1,3 and 2,4) were also significant. This correlates to the view of experienced observers who confirm that the lateral transitions help to establish a trade-off between the diagnoses for each lung but the most significant movements are the anterior/posterior comparisons. FIG. 6 also indicates that diagonal comparisons were rare.

In addition to this temporal analysis automatic extraction of dominant visual features ie image attributes that are most relevant to the observation of domain experts is carried out using factor analysis for multivariate data. The cornerstone of factor analytic theory is the postulate that there exist internal attributes (i.e. unobservable characteristics) that are more fundamental than surface attributes (i.e. measurable characteristics). For example in the present case sixteen possible image attributes have been identified which may be related to the fixation points identified by the experienced observer. As these relate, in the present case, to textural attributes the experienced observer will not be able consciously to identify which of these underlying features is in fact significant. However by examining the conclusions reached by the observer, i.e. those points or clusters of points on which he fixates, factor analysis can identify which of the sixteen possible image attributes are in fact significant. It may be that only one of the attributes is significant or a combination of attributes. Central to the factor analysis is the definition of common factors as internal attributes that affect more than one surface attribute. Hence, the primary objective of this method is to determine the number and nature of those factors, and the pattern of their influences on the surface attributes. In simple terms, factor analysis reduces the number of variables to be considered by creating new variables that are linear combinations of the original ones such that the new variables contain most or all of the information conveyed by the old set of variables. In the present instance the goal is to identify the image attributes which are dominant in the analysis of the relevant images.

Appropriate factor analysis techniques will be known to the skilled reader, such as Diagonal Analysis, Varimax and Promax as described in R. L. Gorsuch, Factor Analysis. W.B. Saunders Company, 1974, H. H. Harman, Modern Factor Analysis, the University of Chicago Press, 1970, R. Reyment and K. G. Jöreskog, Applied Factor Analysis in the Natural Sciences, Cambridge University Press, 1996, and S. De Backer, P. Scheunders, “Texture Segmentation by Frequency-Sensitive Elliptical Competitive Learning,” in Proc. IEEE IC1AP99, Venice, Italy, September, pp. 64-69, 1999, all of which are incorporated herein by reference.

Diagonal Analysis uses the assumption that the factors correspond to original (not the combination of) variables and it determines the extent to which each factor can account for the observed fixation. In the context of the present invention this technique determines the single dominant visual feature that is most important to the visual assessment by the domain expert. With diagonal analysis, the next factor is subsequently set to the next most dominant of the remaining possible factors. The process is iterated until the desired number of factors is extracted from the data.

As an alternative to the diagonal analysis method, a feature extractor can also be formed by combining a subset of existing visual features based on factor analysis using rotation methods such as Varimax and Promax. These factor analysis methods are discussed in more detail in the appendix.

The extracted image features and the temporal order with which they were compared derived respectively from the aforementioned factor analysis and Markov modelling, can be used individually or in combination for training in analysing vascular redistribution CT images. A minimum training is preferably given beforehand by explaining the basic aspects of the image findings related to vascular redistribution and indicating the appearance of the visual cues that may be used by the experts.

For example, based on the identified significant image attributes, an appropriately enhanced image can be shown to the trainee in order that they develop the capability to identify the relevant regions of interest quickly. Alternatively the trainees' eye movements can be tracked and the system can identify areas which the trainee failed to fixate on. Alternatively still a basic decision support system can be introduced where the trainees' analysis is compared with archived analysis as discussed in more detail below.

Following on from the Markov analysis, if the trainees' eye movements are tracked then the transitions made can be compared against the Markov matrix to establish whether the trainee has been carrying out the correct scan path sequence. Alternatively, as part of the training mode, the sequence in which states are observed can be demonstrated on screen by highlighting one state after the other (enhanced or otherwise) in the appropriate sequence.

In relation to the sequential analysis it will be noted that this can be between different states on a single image, or successive images or slices in a 3-dimensional implementation.

In a decision support system, the system is calibrated as discussed above, but in addition to the factor analysis of the observer's visual scan, the observer's diagnosis is also recorded. Although this requires verbal interaction, it will be noted that there is still no requirement for the observer to explain why the specific diagnosis was reached—factor analysis allows the system to identify which, for example textural, attribute or attributes are relevant for a given diagnosis. Subsequently, when a radiologist is observing a new image, the system can identify possible alternative or additional diagnoses to that input by the radiologist based on the database it has built up. The system can indeed be self-learning, logging the additional diagnoses each time the system is used. In addition the steps described above in relation to the training mode can be applied equally here as an aid to the radiologist.

In a test set-up the dynamics derived from the eye movements (i.e. comparison anterior/posterior and lateral) through Markov Modelling were replicated over original CT images and their feature representations. The results were then compared with those by the most experienced radiologist. FIG. 8 illustrates the assessment results based on the four different statistical criteria for four novices. It is evident that there was a clear improvement in the quality of the diagnoses when the features selected by the factor analysis techniques instead of the original images were shown to the observers. Overall, there was a significant improvement in the specificity and conformance measures for all novices. However a single dominant feature determined by diagonal analysis or combined features from Varimax both provide good results.

One of the strengths of the described framework is that it is able to determine automatically the significant feature extractors from a generic feature library. It will be appreciated that additional or alternative features can be incorporated. It is the grouping that conveys information about the type of features that play a central role in the process, since it helps to envisage the abstract concepts involved in the decision making process. The relevant extracted features can be identified using any appropriate analytical technique and a larger number can be combined dependent on computational power.

The Markov Model described above is simple and the use of projected fixation points after normalisation is preferred. The validity of using spatial information alone for determining the states of the Markov Model is an alternative possibility. Of course alternative techniques can be used for analysing the expert's scanning sequence.

The approach described herein can be applied to any appropriate image scanning field, including other image modes than HRCT, other areas of medical image analysis and image recognition fields outside the medical arena. Similarly the technique can be applied to static or moving images.

For example the technique can be used for any surgical microscope for recording the performance of the operator and analysing their visual behaviour during surgery. According to this technique the eye movements of the operator during surgery are monitored to assess once again the specific area fixated on. This can be used once again either to form the basis of a decision support network or indeed to review the performance of a surgeon as part of a training exercise.

Yet further, where the operator is studying an image or object, analysis of the fixation points and eye movement of the operator can be used in gaze guided image analysis to automate and speed up certain analysis steps, for example. Thus when the operator is using a normal microscope the system assesses what types of feature the operator is looking at and can help identify other similar features for the operator's attention. As a specific example, if the operator is counting a certain type of cell, once the system has identified what those cells are by monitoring the eye movements of the operator they can assist in identifying further cells of the same type and thus the counting operating.

It will be appreciated that throughout the description that the invention could generally extend to the analysis of both images and physical objects where appropriate, and the term “image” can be understood in that context. In each case, explicit domain knowledge in initially narrowing down the possible relevant feature extractors from the library can speed up the factor analysis stage. It will be recognised that the analysis can be implemented in software in any appropriate manner.

Appendix: Factor Analysis

Factor analysis theory is based upon the postulate that there exist internal attributes (i.e. attributes that cannot be directly measured), commonly referred to as factors, whose effects are reflected on surface attributes (i.e. measurable features). Within the set of internal attributes, it is possible to distinguish between common factors and specific factors. Common factors are those which affect more than one surface attribute, whereas specific factors only affect one of the surface attributes. In addition to the two types of factors presented, each surface attribute is also affected by errors of measurement. Thus, following the factor analysis theory, the variance on the surface attributes may be seen as arising from these three sources. The fraction of variance accounted for by the common factors is known as the communality.

The common factor model may be expressed as:
z=xF^{T} (2)
where z represents each modelled surface attribute (i.e. the image attributes or feature extractor described above) equated with a linear combination of the measures on the “common factors” x, and F is the factor loadings matrix that contains the weights which represent the effects of the factors on the attributes. Such matrix is calculated in the proposed methodology by applying the Varimax and Promax procedures. These algorithms are presented in detail herein.

In Equation 2, T stands for matrix transpose. The factor loading matrix F is obtained from the correlation matrices of measured visual features at fixation points. The correlation matrix is a square symmetric matrix that contains the minor product moment (see equation (4)) below) of the standardised data matrix Z that is defined as follows:

Let us assume that we have a set of m observations, each of them n-dimensional:

$${\vec{x}}^{1} = ( {x}_{1}^{1} , {x}_{2}^{1} , … {x}_{n}^{1} ) \\ {\vec{x}}^{2} = ( {x}_{1}^{2} , {x}_{2}^{2} , … , {x}_{n}^{2} ) \\ ⋮ \\ {\vec{x}}^{m} = ( {x}_{1}^{m} , {x}_{2}^{m} , … , {x}_{n}^{m} ) \qquad ( 3 )$$

Since standardised variables have a mean of zero and a standard deviation (σ) of 1, the standardised data matrix can be calculated as:

$$Z = ( \begin{matrix}\frac{{x}_{1}^{1} - {\vec{x}}_{1}}{1} & ⋯ & \frac{{x}_{n}^{1} - {\vec{x}}_{n}}{n} \\ ⋮ & ⋰ & ⋮ \\ \frac{{x}_{1}^{m} - {\vec{x}}_{1}}{1} & ⋯ & \frac{{x}_{n}^{m} - {\vec{x}}_{n}}{n}\end{matrix} )$$

where σᵢ is the standard deviation of the variable xᵢ throughout the m samples and \vec{x}ₗ is its mean. The number of samples is determined by the number of fixations done by the observers, whereas the number of features or variables xᵢ are defined by the feature library and constitutes the battery of surface attributes considered. The correlation matrix X is defined from X such that
X=Z^{T}Z/m, (4)
where the superscript T indicates the transpose of the matrix. The correlation matrix is a symmetric and real-valued matrix of size n×n. The correlation is one of the most useful statistics. Intuitively, the correlation is a single number that describes the degree of relationship between two variables. When dealing with more than two variables such concept is extended to that of correlation matrix, including the correlation between every pair of variables.

Diagonal Analysis determines the extent to which each factor can account for the entire correlation matrix. The next factor is subsequently set to the variable that accounts for the maximum variance in the residual correlation matrix and so on.

Varimax and Promax provide rotation of the reference axes after Principal Component Analysis (PCA) to determine the most important contributing loadings and diminish the less significant ones.

PCA is a technique to reduce the dimensionality of data. It is based upon finding a transformation, typically a linear transformation, of the co-ordinate system such that the variance of the data along some of the new directions is suitably small and, therefore, these particular new directions may be ignored. Thus, PCA seeks for the direction on which the data have maximum variance and having found it, it finds another direction perpendicular to the first, along which the variation of the data is the least. The method obtains such transformation as follows:

Let us consider the covariance matrix, C, of the data (i.e. identical to the correlation matrix but without the ratio related to the standard deviation), thus C is defined from P as C=P^{T}P/m, where P is

$$P = ( \begin{matrix}{x}_{1}^{1} - {\vec{x}}_{1} & ⋯ & {x}_{n}^{1} - {\vec{x}}_{n} \\ ⋮ & ⋰ & ⋮ \\ {x}_{1}^{m} - {\vec{x}}_{1} & ⋯ & {x}_{n}^{m} - {\vec{x}}_{n}\end{matrix} )$$

This matrix is symmetric and real-valued so its n eigenvalues are real and its eigenvectors are mutually orthogonal to each other. The eigenvector corresponding to the largest eigenvalue of the covariance matrix indicates the direction along which the data have the largest variance. Furthermore, the eigenvectors taken in order of size of their associated eigenvalues provide the directions sought by the method. Finally, the dimensionality reduction is achieved by ignoring those directions (i.e. eigenvectors) with suitably small eigenvalues.

Varimax is perhaps the most popular of all analytical rotational procedures which aims at simplifying the columns of the unrotated factor matrix (F) by having a few high loadings and many zero, or near-zero, loadings (F′).

This may be achieved by considering the notion of variance of the factor loadings from matrix F in view of the fact that the variance of the factor will be at its maximum when the elements of the vector of loadings, for a given factor, approaches ones and zeros. The first step is calculation of the correlation matrix (data have been standardised since the scale of variation of the variables greatly differs) as described above. PCA is used to derive the principal factors, and only those factors with the largest eigenvalues are regarded as principal factors. The optimal orientation of the factors is then obtained.

Complications due to signs of the factors loadings may be avoided if the variance of the squared factor loadings is used.

$${s}_{j}^{2} = \frac{1}{p} {\sum }_{i = 1}^{p} {( {f}_{ij}^{′2} )}^{2} - {\frac{1}{{p}^{2}} [ {\sum }_{i = 1}^{p} {f}_{ij}^{′2} ]}^{2} \qquad ( 5 )$$

where f′ᵢⱼ is the loading factor in the new axes representation and p is the dimensionality of the factors (e.g. 16 in the present case).

For the entire matrix of factor loadings, this is achieved when the sum of each individual factor variance, S_{T}², is at a maximum

$${s}_{T}^{2} = {\sum }_{i = 1}^{k} {s}_{j}^{2} = \frac{1}{p} {\sum }_{j = l}^{k} {\sum }_{i = l}^{p} ( {f}_{ij}^{′4} ) - \frac{1}{{p}^{2}} {\sum }_{j = l}^{k} {[ {\sum }_{i = 1}^{p} {f}_{ij}^{′2} ]}^{2} \qquad ( 6 )$$

Each row of the matrix is normalised to a unit length before the variance is computed. After rotation, the rows are rescaled to their original lengths. Since the sum of the squared elements of a row of the factor matrix is equal to the communality of the variable, the normalisation is obtained by dividing each element in a row by the square root of the associated communality (hᵢ²).

Therefore, the final quantity to be maximised for producing a simpler structure becomes:

$${s}_{v}^{2} = {p}^{2} {s}_{T}^{2} = p {{\sum }_{j = l}}^{k} {\sum }_{i = l}^{p} {[ \frac{{f}_{ij}^{′}}{{h}_{i}} ]}^{4} - {\sum }_{j = l}^{k} {[ {\sum }_{i = l}^{p} \frac{{f}_{ij}^{′2}}{{h}^{2}} ]}^{2} \qquad ( 7 )$$

For any pair of factors, j and l, the quantity to be maximised is

$${s}_{( {v}_{jl} )}^{2} = p [ {\sum }_{i = 1}^{p} {( \frac{{f}_{ij}^{′}}{{h}_{i}} )}^{4} + {\sum }_{i = 1}^{p} {( \frac{{f}_{il}^{′}}{{h}_{i}} )}^{4} ] - [ {\sum }_{i = 1}^{p} {( \frac{{f}_{ij}^{′2}}{{h}_{i}^{2}} )}^{2} - {\sum }_{i = 1}^{p} {( \frac{{f}_{il}^{′2}}{{h}_{i}^{2}} )}^{2} ] \qquad ( 8 )$$

To maximise the previous equation the factor axes j and l can be rotated through some angle θⱼₗ such that Equation (8) is a maximum while leaving all other factor axes unchanged. By repeating this procedure on pairs for all possible factors, Equation (7) will be maximised.

Since the rigid rotation of original axes (i.e. F is the matrix of unrotated factor loadings) can be performed by:
f′ᵢⱼ=fᵢⱼ cos θⱼₗ+fᵢₗ sin θⱼₗ
f′ᵢₗ=−fᵢⱼ sin θⱼₗ+fᵢₗ cos θⱼₗ (9)

One can substitute these expressions for f into Equation (8) and differentiate with respect to θⱼₗ. By setting the derivative to zero and solving for θⱼₗ, it gives the angle through which factors j and l must be rotated so as to maximise Equation (8).

The determination of θⱼₗ for each of the possible pairs of j and l factors is iterated to obtain new values sᵥ that will be as large or larger than that obtained in the previous iteration. The final transformation matrix can be viewed as an operator that transforms the unrotated factor matrix F into the rotated factor matrix F′.

It is worth noting that only orthogonal solutions are obtained by means of the Varimax approach, which may not necessarily be the most optimal solution. To alleviate this problem, the Promax method uses oblique rotation and removes the constraint of component orthogonality. The Promax method, derived from “oblique Procrustean transformation” may be used for obtaining an oblique simple-structure solution. Its main characteristics are:
1. The Promax procedure is initialised with the Varimax loading factors as prior estimates.
2. The diagonal entries of the correlation matrix are substituted by the communalities (i.e. variance due to the common factors) as estimated from the Squared Multiple Correlation method (SMC). The SMC is obtained from a multiple linear regression of each features with all the other features in the library. To obtain the SMC for all the features one should calculated the inverse Z⁻¹ of the correlation matrix Z. Then, the SMC for a given feature j, is given by

$${SMC}_{j} = 1 - \frac{1}{{r}^{jj}} \qquad ( 10 )$$

where r^{jj} is the diagonal element in Z⁻¹ associated with the feature j.
3. The optimal orientation of the factors is obtained.

To obtain the optimal orientation, one should follow these steps:
1. Development of a target matrix: The original matrix of actor loadings if the Varimax output that has been rotated to orthogonal simple structure. This matrix is normalised by columns and rows so that the vector lengths of both variables and factors are set to the unity.
2. The elements of the matrix are raised ot the power 4 and, therefore, all loadings are decreased. This results in an ideal pattern matrix (F*) which should have its loadings as near to 0 or 1 as possible.
3. Least-square fit of the Varimax matrix: Some transformation matrix (Tᵣ) is needed to rotate the Varimax factor axes to new positions (Sᵣ=FTᵣ). One aims to determine Tᵣ in such a way that Sᵣ is as close to F* as possible in the least-squares sense. The elements of Tᵣ are the direction cosines between the orthogonal axes and the oblique axes. The least-squares solution for Tᵣ is obtained as:
   Tᵣ=(F^{T}F)⁻¹F^{T}F* (11)
4. The reference structure transformation is related to the primary structure transformation matrix, Tₚ, by T^{T}_{P}=Tᵣ⁻¹, and T^{T}_{P} is thereafter normalised. Finally, the primary factor pattern matrix P_{P} is defined by P_{P}=B(T^{T}_{P})⁻¹.

Given the fact that the Promax results are related to non-orthogonal axes, it is preferable to define new features on the basis of the Varimax procedure since its definition is simpler and more intuitive. Hence, a set of new images can be defined by using the following definition:

$${V}_{new} = {\sum }_{i} {v}_{i} \cdot {f}_{I} \qquad ( 12 )$$

where v_{new} is the new feature, v are the features reported in Table 1 and f are factor loadings. Only those loadings above a certain threshold are considered in this embodiment in the definition of the new feature.

In the example described herein, the relevant image attributes relied upon in image analysis are selected from the 16 textural extractors from the image feature library. Diagonal analysis was performed giving the results shown in Table 3 which gives the different feature or attribute indices, and it is evident that Grey-level uniformity (glu), which measures the grey-level dispersion of the primitives, is the dominant feature according to this criterion. As is well known, a high glu value denotes a textural pattern where primitives belong to a small number of grey levels, as in a check-board pattern.

TABLE 3

| | Sum of squared |
|---|---|
| Feature Extractor | correlations |
| Contrast | 6.8924 |
| Energy | 8.8602 |
| (Co-occurrence) Entropy | 9.0121 |
| Homogeneity | 9.1130 |
| Maximum | 9.5183 |
| Image Entropy | 3.5897 |
| Fractal Dimension | 7.0109 |
| Absolute Deviation | 5.0165 |
| Kurtosis | 3.7479 |
| Mean | 8.5696 |
| Skewness | 7.6237 |
| Standard deviation | 5.5735 |
| Grey Level Uniforimty | 9.5543 |
| Long primitive emphasis | 5.8597 |
| Primitive length uniformity | 8.6467 |
| Short primitive emphasis | 6.0556 |

In order to reveal the internal correlation of all the feature extractors used, i.e. which variables are important to the description of the principal factors and how different groups of variables may account for more general characteristics, Varimax and Promax analyses were performed. It is observed that the three factors illustrated in Table 4 were sufficient to account for most of the information conveyed by the whole data set.

TABLE 4

| | 1st Principal | 2nd Principal | 3rd Principal |
|---|---|---|---|
| | Component | Component | Component |
| Eigenvalues | 10.3 | 2.35 | 1.42 |
| Contrast | −0.2465 | −0.0829 | −0.4438 |
| Energy | −0.2844 | −0.2161 | −0.0848 |
| (Co-occurrence) Entropy | 0.287 | 0.1889 | 0.1918 |
| Homogeneity | −0.2894 | −0.1646 | −0.1949 |
| Maximum | −0.2977 | −0.144 | 0.0011 |
| Image Entropy | 0.1533 | 0.2945 | −0.5229 |
| Fractal Dimension | −0.2424 | 0.3702 | 0.0232 |
| Absolute Deviation | −0.1845 | 0.4986 | 0.0451 |
| Kurtosis | −0.1647 | −0.2180 | 0.4518 |
| Mean | 0.2779 | −0.2530 | −0.0592 |
| Skewness | −0.265 | 0.1198 | −0.0941 |
| Standard deviation | −0.2019 | 0.4661 | 0.0831 |
| Grey Level Uniforimty | −0.2981 | −0.1481 | 0.0004 |
| Long primitive emphasis | −0.2256 | 0.0303 | 0.3 |
| Primitive length uniformity | −0.2815 | −0.1514 | −0.2296 |
| Short primitive emphasis | 0.2301 | 0.0425 | −0.2809 |

The coefficients indicate the weight (or loading) of each variable in the definition of the factor. Further analysis can be applied to determine from these weights which variables contribute the most. This is particularly the case for the first factor as the loadings are fairly evenly distributed. To facilitate interpretation, a rotation of the axes is undertaken by making use of the Varimax approximation. The loadings for the new axes are provided in Table 5.

TABLE 5

| | 1st Factor | 2nd Factor | 3rd Factor |
|---|---|---|---|
| Contrast | −0.4266 | 0.0489 | −0.2833 |
| Energy | −0.3555 | −0.0297 | 0.0866 |
| (Co-occurrence) Entropy | 0.3931 | 0.0092 | 0.0151 |
| Homogeneity | −0.3849 | 0.0123 | −0.0237 |
| Maximum | −0.2927 | 0.0410 | 0.1484 |
| Image Entropy | 0.0181 | 0.1455 | −0.6018 |
| Fractal Dimension | 0.0016 | 0.4430 | 0.0079 |
| Absolute Deviation | 0.1157 | 0.5198 | −0.0285 |
| Kurtosis | −0.0228 | −0.0776 | 0.5218 |
| Mean | 0.0642 | −0.3653 | −0.0848 |
| Skewness | −0.1867 | 0.2412 | −0.0202 |
| Standard deviation | 0.1045 | 0.5036 | 0.0204 |
| Grey Level Uniforimty | −0.2953 | 0.0377 | 0.1490 |
| Long primitive emphasis | −0.0206 | 0.1584 | 0.3410 |
| Primitive length uniformity | −0.3884 | 0.0179 | −0.0610 |
| Short primitive emphasis | 0.0269 | −0.1705 | −0.3223 |

From Table 5, it can be observed that features such as contrast, energy, entropy and homogeneity, primitive length uniformity as well as Grey-level uniformity have the largest factor loadings f. Since the first factor contains the most significant amount of information compared to other factors, a new image feature can be calculated. This is calculated by using weighted average of those variables with large weights in absolute values. In order to verify if the results are similar when the orthogonality constraint is removed, the Promax method is also implemented. Instead of using the correlation values in the diagonal entries, an estimate of the communalities, as given by the Squared Multiple Correlation (SMC) method are considered. The factor loading values for the axes obtained after oblique rotation are shown in Table 6, which are in agreement with the results obtained from Varimax.

TABLE 6

| | Communalities | 1st Factor | 2nd Factor | 3rd Factor |
|---|---|---|---|---|
| Contrast | 0.9697 | 0.5319 | −0.0239 | 0.3720 |
| Energy | 0.9917 | 0.3425 | −0.1084 | −0.0821 |
| (Co-occurrence) | 0.9990 | −0.4163 | 0.0911 | −0.0467 |
| Entropy | | | | |
| Homogeneity | 0.9983 | 0.4125 | −0.0661 | 0.0638 |
| Maximum | 0.9771 | 0.2649 | −0.0218 | −0.1319 |
| Image Entropy | 0.8839 | 0.1543 | 0.1726 | 0.6932 |
| Fractal Dimension | 0.9538 | 0.0440 | 0.4667 | 0.1495 |
| Absolute Deviation | 0.9975 | −0.0588 | 0.5817 | 0.2132 |
| Kurtosis | 0.8863 | −0.1218 | −0.1003 | −0.5842 |
| Mean | 0.9849 | −0.0797 | −0.3726 | −0.0399 |
| Skewness | 0.9531 | 0.2243 | 0.2168 | 0.1210 |
| Standard deviation | 0.9980 | −0.0638 | 0.5603 | 0.1518 |
| Grey Level | 0.9875 | 0.2674 | −0.0261 | −0.1341 |
| Uniforimty | | | | |
| Long primitive | 0.8765 | −0.0459 | 0.1437 | 0.3072 |
| emphasis | | | | |
| Primitive length | 0.9842 | 0.4254 | −0.0579 | 0.1073 |
| uniformity | | | | |
| Short primitive | 0.8983 | 0.0361 | −0.1564 | 0.2870 |
| emphasis | | | | |

The application of the described factor analysis offers two possibilities of using the image feature library for decision support, one relying on the single most dominant feature extractor, in this case the Grey-level Unifonnity, and the other by combining a group of salient features determined by the Varimax algorithm. FIG. 7 illustrates an example CT image and its corresponding feature representations determined by factor analysis where the significant image attributes are enhanced.

1. A method of analysing an image comprising the steps of:
tracking the eye movements of an observer observing the image,
identifying one or more fixation regions fixated by the observer and
extracting, from a range of possible underlying image attributes, one or more image attributes associated with the fixation region.

2. A method as claimed in claim 1 in which the one or more image attributes is extracted by factor analysis.

3. A method as claimed in claim 1 in which the one or more image attributes is obtained from a feature extraction library.

4. A method as claimed in claim 3 in which the range of possible underlying image attributes comprises a subset of all image attributes in the feature extraction library identified based on explicit domain knowledge.

5. A method as claimed in claim 1 in which the fixation region is identified by k-mean elliptical clustering.

6. A method of developing a decision support system comprising the steps of:
tracking the eye movements of an observer observing the image,
identifying one or more fixation regions fixated by the observer,
extracting, from a range of possible underlying image attributes, one or more image attributes associated with the fixation region, and
correlating the extracted attributes against the observer's verbal analysis of the image.

7. A method of developing an image analysis training system comprising the steps of
tracking the eye movements of an observer observing the image,
identifying one or more fixation regions fixated by the observer,
extracting, from a range of possible underlying image attributes, one or more image attributes associated with the fixation region, and
representing the image attributes to a trainee.

8. A method as claimed in claim 1 further comprising the step of identifying a transition sequence between fixation regions.

9. A method as claimed in claim 8 in which the transition sequence is derived using Markov modelling.

10. A method as claimed in claim 1 in which the image comprises a physical object or a representation of a physical object.

11. A method as claimed in claim 1 in which the image is generated during surgery and the observer is a surgical operator.

12. A method as claimed in claim 1 in which a processor searches for further image attributes corresponding to the identified image attributes.

13. A method of as claimed in claim 12, further comprising providing gaze guided image analysis by performing the step of guiding the observer's gaze to image regions including the further image attributes that are searched for by the processor.

14. A method of extracting image attributes from an image comprising the step of applying factor analysis to the tracked scan of the image by an observer.

15. An image analysis system, comprising:
an image display,
an eye-tracker and
a processor for processing tracked data to identify significant underlying image attributes.

16. A computer-readable medium comprising one or more sequences of instructions which, when executed by one or more processors, cause the one or more processors to perform the steps of any of claim 1, 2, 3, 4, 5, 6, 7, 8, 9, 10, 11, 12, 13, or 14.

17. An image analysis system, comprising:
an image display;
an eye-tracker;
a processor for processing tracked data to identify significant underlying image attributes; and
a computer-readable medium comprising one or more sequences of instructions which, when executed by the processor, cause the processor to perform the steps of any of claim 1, 2, 3, 4, 5, 6, 7, 8, 9, 10, 11, 12. 13, or 14.
